(19) United States
(12) Patent Application Publication
(10) Pub. No.: US 2023/0021722 A1
(43) Pub. Date: Jan. 26, 2023

(54) APPARATUS AND METHOD FOR PERFORMING MOTION VECTOR REFINEMENT TO GET MORE PRECISE MOTION VECTORS

(71) Applicant: MEDIATEK INC., Hsin-Chu (TW)

(72) Inventors: Kai-Chun Lin, Hsinchu City (TW); Sheng-Jen Wang, Hsinchu City (TW); Chi-Hung Chen, Hsinchu City (TW)

(73) Assignee: MEDIATEK INC., Hsin-Chu (TW)

(21) Appl. No.: 17/586,742

(22) Filed: Jan. 27, 2022

Related U.S. Application Data
(60) Provisional application No. 63/223,572, filed on Jul. 20, 2021.

(51) Int. Cl. H04N 19/137; H04N 19/105; H04N 19/80; H04N 19/176

(52) U.S. Cl. CPC H04N 19/137; H04N 19/105; H04N 19/80; H04N 19/176

(57) ABSTRACT

A motion vector refinement apparatus includes a storage device, a reference block fetch circuit, and a processing circuit. The reference block fetch circuit fetches a forward reference block and a backward reference block according to at least specified motion vectors (MVs) of a current block, and stores the forward reference block and the backward reference block into the storage device. The processing circuit derives a first reference block from the forward reference block and a second reference block from the backward reference block, calculates at least one accumulated pixel difference (APD) value for at least one block pair each having a first block found in the first reference block and a second block found in the second reference block, and determines an offset setting for motion vector refinement of the specified MVs according to the at least one APD value.

### CROSS REFERENCE TO RELATED APPLICATIONS

This application claims the benefit of U.S. provisional application No. 63/223,572, filed on Jul. 20, 2021 and incorporated herein by reference.

### BACKGROUND

The present invention relates to pre-processing for motion compensation, and more particularly, to an apparatus and method for performing motion vector refinement to get more precise motion vectors used in motion compensation.

The conventional video coding standards generally adopt a block based coding technique to exploit spatial and temporal redundancy. For example, the basic approach is to divide the whole source picture into a plurality of blocks, perform intra/inter prediction on each block, transform residues of each block, and perform quantization and entropy encoding. Besides, a reconstructed picture is generated in a coding loop to provide reference pixel data used for coding following blocks. For certain video coding standards, in-loop filter(s) may be used for enhancing the image quality of the reconstructed frame.

The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, a reconstruction circuit, and in-loop filter(s). Motion information of a current block may be directly set by motion information of a spatially or temporally neighboring block, and thus may suffer from reduced precision. Hence, there is a need for an innovative motion vector refinement scheme for increasing the precision of motion vectors that are used in motion compensation.

### SUMMARY

One of the objectives of the claimed invention is to provide an apparatus and method for performing motion vector refinement to get more precise motion vectors used in motion compensation.

According to a first aspect of the present invention, an exemplary motion vector refinement apparatus is disclosed. The exemplary motion vector refinement apparatus includes a storage device, a reference block fetch circuit, and a processing circuit. The reference block fetch circuit is arranged to fetch a forward reference block in a forward reference picture and a backward reference block in a backward reference picture according to at least specified motion vectors (MVs) of a current block in a current picture, and store the forward reference block and the backward reference block into the storage device. The processing circuit is arranged to derive a first reference block from the forward reference block and a second reference block from the backward reference block, calculate at least one accumulated pixel difference (APD) value for at least one block pair each having a first block found in the first reference block and a second block found in the second reference block, and determine an offset setting for motion vector refinement of the specified MVs according to said at least one APD value.

According to a second aspect of the present invention, an exemplary motion vector refinement method is disclosed. The exemplary motion vector refinement method includes: fetching a forward reference block in a forward reference picture and a backward reference block in a backward reference picture according to at least specified motion vectors (MVs) of a current block in a current picture; deriving a first reference block from the forward reference block and a second reference block from the backward reference block; calculating, by an offset calculation circuit, at least one accumulated pixel difference (APD) value for at least one block pair, each having a first candidate block found in the first reference block and a second candidate block found in the second reference block; and according to said at least one APD value, determining an offset setting for motion vector refinement of the specified MVs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a concept of a proposed motion vector refinement scheme according to an embodiment of the present invention.

FIG. 2 is a block diagram illustrating a motion vector refinement apparatus according to an embodiment of the present invention.

FIG. 3 is a diagram illustrating an example of a reference block fetched by the reference block fetch circuit shown in FIG. 2.

FIG. 4 is a diagram illustrating a first design of the reference block fetch circuit shown in FIG. 2 according to an embodiment of the present invention.

FIG. 5 is a diagram illustrating a second design of the reference block fetch circuit shown in FIG. 2 according to an embodiment of the present invention.

FIG. 6 is a diagram illustrating a first design of the bilateral filter circuit shown in FIG. 2 according to an embodiment of the present invention.

FIG. 7 is a diagram illustrating a second design of the bilateral filter circuit shown in FIG. 2 according to an embodiment of the present invention.

FIG. 8 is a diagram illustrating a design of the offset calculation circuit shown in FIG. 2 according to an embodiment of the present invention.

FIG. 9 is a diagram illustrating computation of an APD value for a block pair, having one N×M block found in a forward reference block and another N×M block found in a backward reference block, according to an embodiment of the present invention.

FIG. 10 is a diagram illustrating a portion of different integer positions within one reference block according to an embodiment of the present invention.

FIG. 11 is a diagram illustrating APD computation performed at the APD processing circuit for obtaining 5×5 APDs values according to an embodiment of the present invention.

FIG. 12 is a diagram illustrating a spatial distribution of 5×5 APD values according to an embodiment of the present invention.

FIG. 13 is a flowchart illustrating a method for determining the offset setting deltaOffset according to an embodiment of the present invention.

FIG. 14 is a diagram illustrating an output reference block derived from applying shifting and padding to a reference block according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

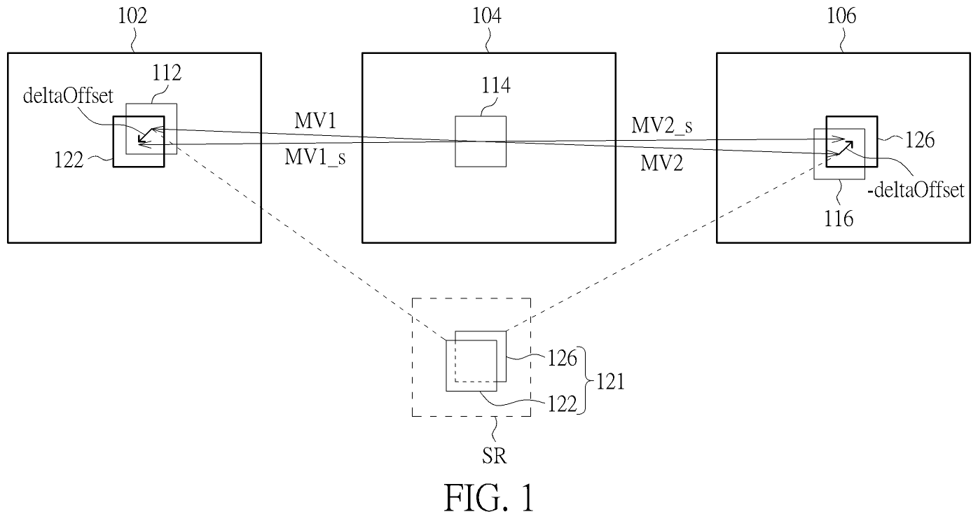

FIG. 1 is a diagram illustrating a concept of a proposed motion vector refinement scheme according to an embodiment of the present invention. A forward reference picture (e.g. one picture included in a reference picture list L0) 102 is in the past with respect to a current picture 104 in a display order. A backward reference picture (e.g. one picture included in a reference picture list L1) 106 is in the future with respect to the current picture 104 in the display order. Regarding a current block 114 in the current picture, specified motion vectors MV1 and MV2 may be obtained from a previously processed block, that is, the specified motion vectors MV1 and MV2 may be set by the same motion vectors possessed by the previously processed block. For example, the previously processed block may be a spatially neighboring block or a temporally neighboring block. As shown in FIG. 1, one specified motion vector MV1 points to a block 112 in the forward reference picture 102, and the other specified motion vector MV2 points to a block 116 in the backward reference picture 106. In accordance with the proposed motion vector refinement scheme, a block pair with the best accumulated pixel difference (APD) is searched within a search range SR. As shown in FIG. 1, a block pair 121 consisting of blocks 122 and 126 is a candidate block pair found having the best APD compared with an original block pair consisting of blocks 112 and 116 and other candidate block pairs. It should be noted that each candidate block pair consists of two blocks with motion vector offsets having the same magnitude but opposite directions.

After the block pair 121 with the best APD is found, an offset setting deltaOffset can be determined based on the block positions of the block pair 121. The offset setting deltaOffset may be decomposed into an X-axis motion vector offset deltaOffsetX and a Y-axis motion vector offset deltaOffsetY. The X-axis motion vector offset deltaOffsetX may be equal to or different from the Y-axis motion vector offset deltaOffsetY. The offset setting deltaOffset may be an integer offset setting or a non-integer offset setting. In a case where the offset setting deltaOffset is an integer offset setting, the X-axis motion vector offset deltaOffsetX and the Y-axis motion vector offset deltaOffsetY are both integer values. In a case where the offset setting deltaOffset is a non-integer offset setting, one or both of the X-axis motion vector offset deltaOffsetX and the Y-axis motion vector offset deltaOffsetY are non-integer values, each consisting of an integer part and a fractional part.

The specified motion vectors MV1 and MV2 are refined by the offset setting deltaOffset. In this way, one refined motion vector MV1_s is set by MV1+deltaOffset, and the other refined motion vector MV2_s is set by MV2−deltaOffset. The refined motion vectors MV1_s and MV2_s are used by motion compensation of the current block 114. Further details of the proposed motion vector refinement scheme are described below with reference to the accompanying drawings.

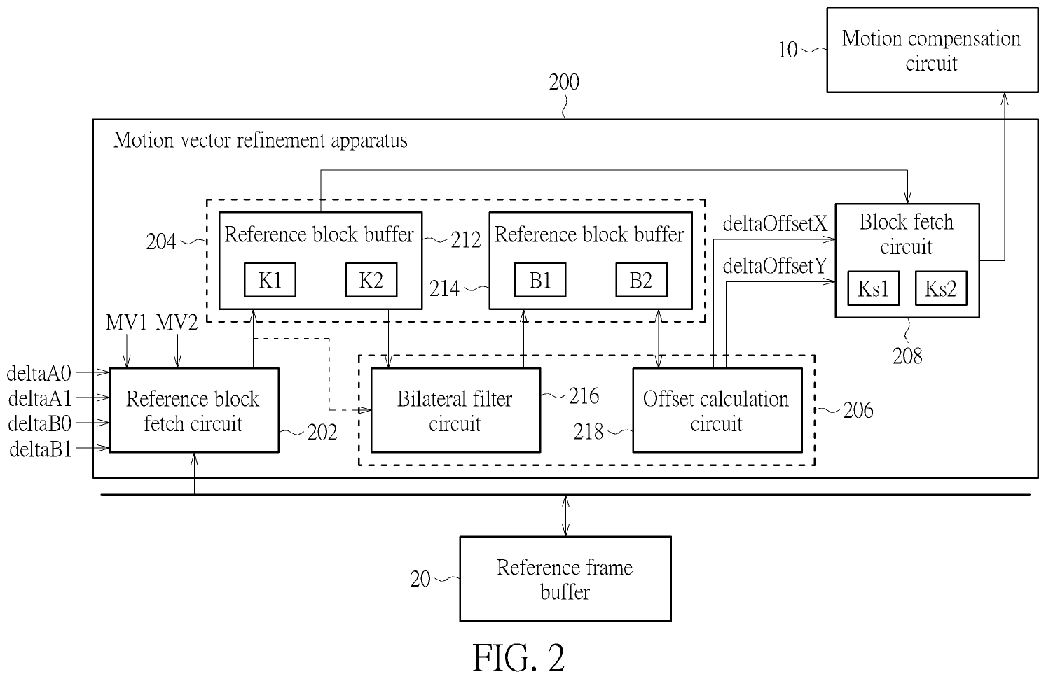

FIG. 2 is a block diagram illustrating a motion vector refinement apparatus according to an embodiment of the present invention. The motion vector refinement apparatus 200 may be a part of a video decoder, and the video decoder is used to deal with decoding of an input bitstream that may be in compliance with a Versatile Video Coding (VVC) standard (also known as H.266 standard). However, this is for illustrative purposes only, and is not meant to be a limitation of the present invention. In practice, any video decoder using the architecture proposed by the present invention falls within the scope of the present invention. The motion vector refinement apparatus 200 includes a reference block fetch circuit 202, a storage device 204, a processing circuit 206, and a block fetch circuit 208. The processing circuit 206 may include a bilateral filter circuit 216 and an offset calculation circuit 218. The storage device 204 may include one reference block buffer 212 for buffering reference blocks fetched by the reference block fetch circuit 202 and another reference block buffer 214 for buffering reference blocks output from the bilateral filter circuit 216.

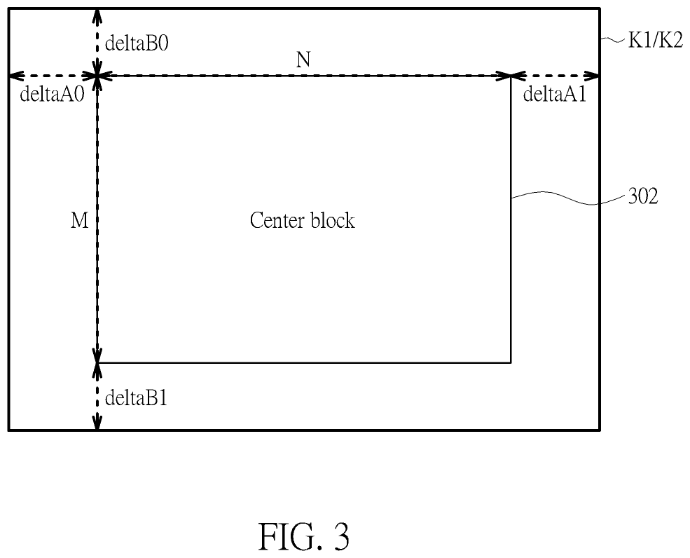

The reference block fetch circuit 202 is arranged to fetch a forward reference block K1 in the forward reference picture 102 (which is stored in the reference frame buffer 20) and a backward reference block K2 in the backward reference picture 106 (which is stored in the reference frame buffer 20) according to at least the specified motion vectors MV1 and MV2 of the current block 114 in the current picture 104, and store the fetched forward reference block K1 and backward reference block K2 into the reference block buffer 212 allocated in the storage device 204. In addition to the specified motion vectors MV1 and MV2 of the current block 114, the reference block fetch circuit 202 may further receive a plurality of parameters deltaA0, deltaA1, deltaB0, deltaB1 that control the size of the fetched reference block K1/K2. The parameters deltaA0, deltaA1, deltaB0, and deltaB1 may depend on a hardware configuration of the motion compensation circuit 10 such as a tap number of a filter used by the motion compensation circuit 10. FIG. 3 is a diagram illustrating an example of a reference block fetched by the reference block fetch circuit 202 shown in FIG. 2. The forward reference block K1 and the backward reference block K2 have the same size. As shown in FIG. 3, a reference block K1/K2 includes an N×M center block 302 found via a corresponding specified motion vector MV1/MV2, and has a size of (N+deltaA0+deltaA1)×(M+deltaB0+deltaB1). The size of the center block 302 is the same as the current block 114 in the current picture 104, where the block width N and the block height M are both positive integers, and the block width N may be identical to or different from the block height M. The parameter deltaA0 specifies an offset between a left boundary of the reference block K1/K2 and a left boundary of the N×M center block 302. The parameter deltaA1 specifies an offset between a right boundary of the reference block K1/K2 and a right boundary of the N×M center block 302. The parameter deltaB0 specifies an offset between a top boundary of the reference block K1/K2 and a top boundary of the N×M center block 302. The parameter deltaB1 specifies an offset between a bottom boundary of the reference block K1/K2 and a bottom boundary of the N×M center block 302.

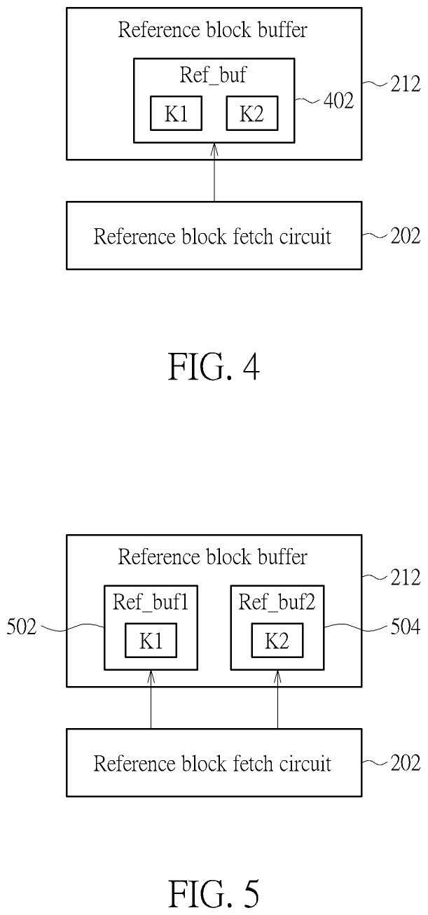

In one exemplary design, the forward reference block K1 and the backward reference block K2 may be fetched in a sequential processing fashion. FIG. 4 is a diagram illustrating a first design of the reference block fetch circuit 202 shown in FIG. 2 according to an embodiment of the present invention. The reference block buffer 212 may be implemented by a single buffer (labeled by “Ref_buf”) 402. The reference block fetch circuit 202 is arranged to start fetching one of the forward reference block K1 and the backward reference block K2 after completing fetching of another of the forward reference block K1 and the backward reference block K2. Hence, the buffer 402 does not receive pixel data of the forward reference block K1 and pixel data of the backward reference block K2 at the same time.

In another exemplary design, the forward reference block K1 and the backward reference block K2 may be fetched in a parallel processing fashion. FIG. 5 is a diagram illustrating a second design of the reference block fetch circuit 202 shown in FIG. 2 according to an embodiment of the present invention. The reference block buffer 212 may be implemented by two separate buffers (labeled by “Ref_buf1” and “Ref_buf2”) 502 and 504. The reference block fetch circuit 202 is arranged to start fetching one of the forward reference block K1 and the backward reference block K2 before completing fetching of another of the forward reference block K1 and the backward reference block K2. Hence, the buffer 502 is allowed to receive pixel data of the forward reference block K1 while the buffer 504 is receiving pixel data of the backward reference block K2; and the buffer 504 is allowed to receive pixel data of the backward reference block K2 while the buffer 502 is receiving pixel data of the forward reference block K1.

Each of the forward reference picture 102 and the backward reference picture 106 consists of integer pixels (i.e. pixels located at integer positions) only. In a case where the specified motion vectors MV1 and MV2 are integer motion vectors, the N×M center block 302 that is included in the forward reference block K1 and pointed to by the specified motion vector MV1 may be the block 112 shown in FIG. 1, and the N×M center block 302 that is included in the backward reference block K2 and pointed to by the specified motion vector MV2 may be the block 116 shown in FIG. 1. In another case where the specified motion vectors MV1 and MV2 are non-integer motion vectors each having an integer part and a fractional part, the N×M center block 302 in the forward reference block K1 is pointed to by the integer part of the specified motion vector MV1 and is therefore different from the block 112 shown in FIG. 1, and the N×M center block 302 in the backward reference block K2 is pointed to by the integer part of the specified motion vector MV2 and is therefore different from the block 116 shown in FIG. 1. To put it simply, the forward reference block K1 only consists of integer pixels selected from the forward reference picture 102, and the backward reference block K2 only consists of integer pixels selected from the backward reference picture 106.

Since the N×M center block 302 in the forward reference block K1 may be deviated from the block 112 shown in FIG. 1 by the fractional part of the specified motion vector MV1 and the N×M center block 302 in the backward reference block K2 may be deviated from the block 116 shown in FIG. 1 by the fractional part of the specified motion vector MV2, the processing circuit 206 may apply pre-processing to the forward reference block K1 and the backward reference block K2 before determining the offset setting deltaOffset for motion vector refinement of the specified motion vectors MV1 and MV2.

The processing circuit 206 is arranged to derive a forward reference block B1 from the forward reference block K1 fetched by the reference block fetch circuit 202, derive a backward reference block B2 from the backward reference block K2 fetched by the reference block fetch circuit 202, and store the forward reference block B1 and the backward reference block B2 into the reference block buffer 214 allocated in the storage device 204. In addition, the processing circuit 206 is further arranged to calculate at least one APD value for at least one block pair, each having a first block found in the forward reference block B1 and a second block found in the backward reference block B2, and determine the offset setting deltaOffset (deltaOffset=(deltaOffsetX, deltaOffsetY)) for motion vector refinement of the specified motion vectors MV1 and MV2 according to the APD value(s). In this embodiment, the bilateral filter circuit 216 is responsible for dealing with derivation of the forward reference block B1 and the backward reference block B2, and the offset calculation circuit 218 is responsible for dealing with determination of the offset setting deltaOffset.

The bilateral filter circuit 216 is arranged to derive the forward reference block B1 by applying bilateral filtering to the forward reference block kl, derive the backward reference block B2 by applying bilateral filtering to the backward reference block K2, and store the forward reference block B1 and the backward reference block B2 into the reference block buffer 214 allocated in the storage device 204.

FIG. 6 is a diagram illustrating a first design of the bilateral filter circuit 216 shown in FIG. 2 according to an embodiment of the present invention. The bilateral filter circuit 216 reads the storage device 204 (particularly, reference block buffer 212 in storage device 204) to obtain the forward reference block K1 and the backward reference block K2 from the storage device 204. The bilateral filter circuit 216 may start applying bilateral filtering to one of the forward reference block K1 and the backward reference block K2 after completing bilateral filtering of another of the forward reference block K1 and the backward reference block K2, or may start applying bilateral filtering to one of the forward reference block K1 and the backward reference block K2 before completing bilateral filtering of another of the forward reference block K1 and the backward reference block K2. In this embodiment, the reference block buffer 214 may include two separate buffers (labeled by “Bi_buf1” and “Bi_buf2”) 602 and 604, where the buffer 602 is used to buffer the forward reference block B1 output from the bilateral filter circuit 216, and the buffer 604 is used to buffer the backward reference block B2 output from the bilateral filter circuit 216.

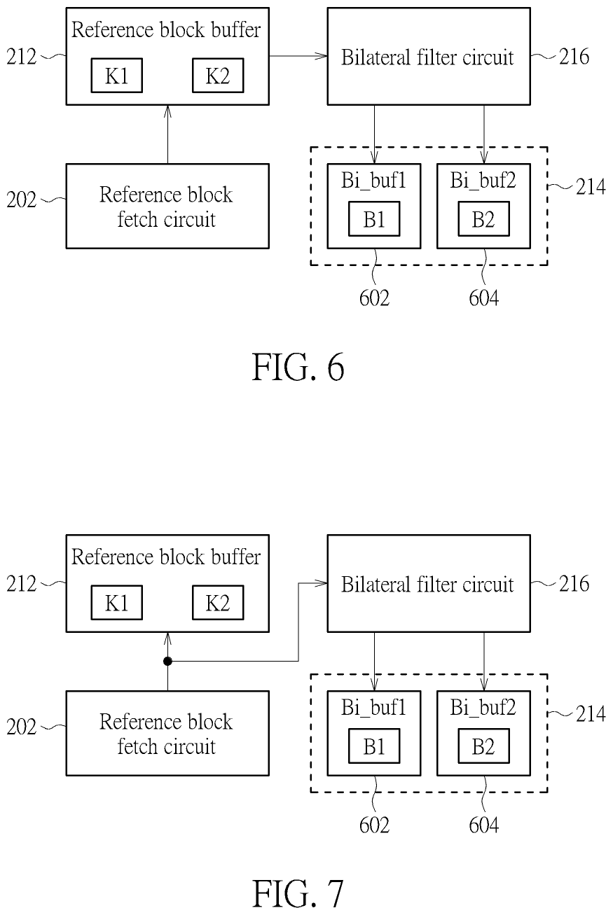

FIG. 7 is a diagram illustrating a second design of the bilateral filter circuit 216 shown in FIG. 2 according to an embodiment of the present invention. The reference block fetch circuit 202 is further arranged to transmit the forward reference block K1 and the backward reference block K2 to the bilateral filter circuit 216. Hence, the bilateral filter circuit 216 does not need to access the reference block buffer 212 for retrieving pixel data of the forward reference block K1 and the backward reference block K2. The bilateral filter circuit 216 may start applying bilateral filtering to one of the forward reference block K1 and the backward reference block K2 after completing bilateral filtering of another of the forward reference block K1 and the backward reference block K2, or may start applying bilateral filtering to one of the forward reference block K1 and the backward reference block K2 before completing bilateral filtering of another of the forward reference block K1 and the backward reference block K2. In this embodiment, the reference block buffer 214 may include two separate buffers (labeled by “Bi_buf1” and “Bi_buf2”) 602 and 604, where the buffer 602 is used to buffer the forward reference block B1 output from the bilateral filter circuit 216, and the buffer 604 is used to buffer the backward reference block B2 output from the bilateral filter circuit 216.

The coefficients set to the bilateral filter circuit 216 depend on the specified motion vectors MV1 and MV2. In a case where the specified motion vectors MV1 and MV2 are integer motion vectors, the coefficients set to the bilateral filter circuit 216 make the forward reference block B1 output from the bilateral filter circuit 216 be identical to the forward reference block K1 fed into the bilateral filter circuit 216, and also make the backward reference block B2 output from the bilateral filter circuit 216 be identical to the backward reference block K2 fed into the bilateral filter circuit 216. In another case where the specified motion vectors MV1 and MV2 are non-integer motion vectors each having an integer part and a fractional part, the coefficients set to the bilateral filter circuit 216 are configured based on the fractional part, such that adjacent integer pixels are blended to determine each fractional pixel (i.e., pixel at a fractional position). The fractional pixels determined based on integer pixels in the forward reference block K1 are treated as integer pixels in the forward reference block B1 output from the bilateral filter circuit 216. Similarly, the fractional pixels determined based on integer pixels in the backward reference block K2 are treated as integer pixels in the backward reference block B2 output from the bilateral filter circuit 216. To put it simply, the integer positions of the reference block B1/B2 are not necessarily the integer positions in the reference picture 102/106 because the specified motion vectors MV1 and MV2 may be non-integer motion vectors.

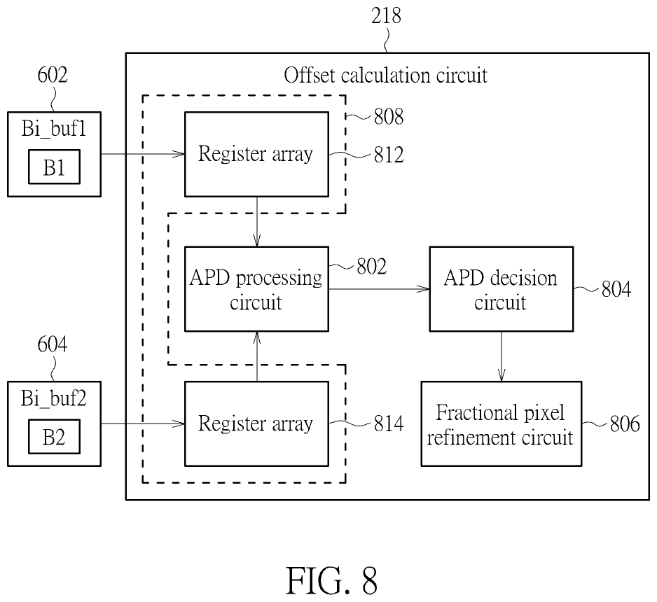

The offset calculation circuit 218 is arranged to find the best APD for determining the offset setting deltaOffset (deltaOffset=(deltaOffsetX, deltaOffsetY)) for motion vector refinement of the specified motion vectors MV1 and MV2. FIG. 8 is a diagram illustrating a design of the offset calculation circuit 218 shown in FIG. 2 according to an embodiment of the present invention. The offset calculation circuit 218 includes an APD processing circuit 802, an APD decision circuit 804, a fractional pixel refinement circuit 806, and a register array device 808. The register array device 808 may include two register arrays 812 and 814, where pixel data of the forward reference block B1 are loaded into the register array 812 from the reference block buffer 214 (particularly, buffer 602 in reference block buffer 214), and pixel data of the backward reference block B2 are loaded into the register array 814 from the reference block buffer 214 (particularly, buffer 604 in reference block buffer 214).

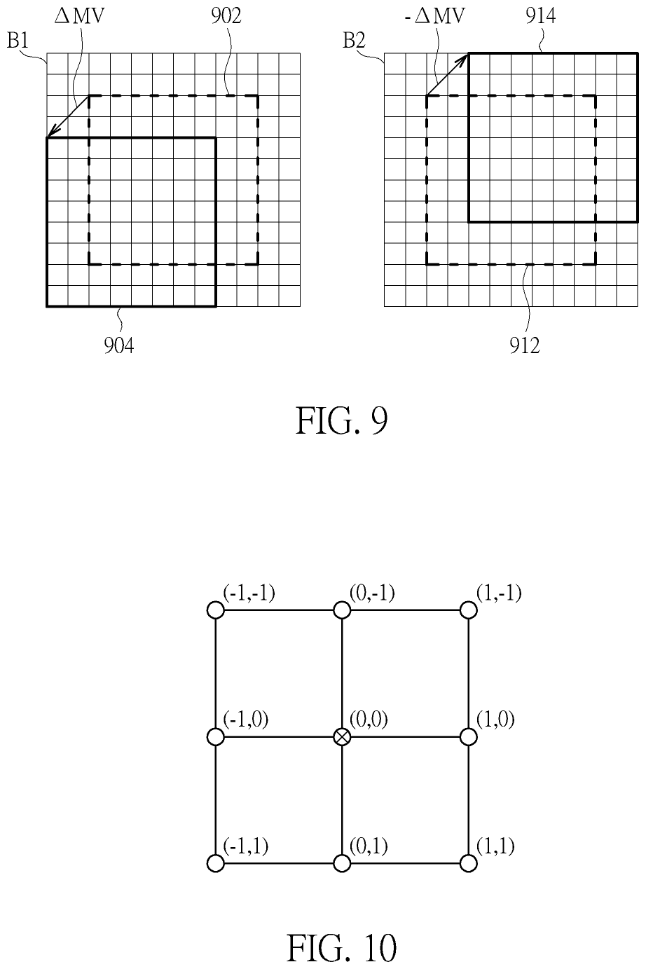

Regarding the offset calculation circuit 218, the APD processing circuit 802 is responsible for dealing with APD computation, and the APD decision circuit 804 is responsible for dealing with search of the best APD. Please refer to FIG. 9 in conjunction with FIG. 10. FIG. 9 is a diagram illustrating computation of an APD value for a block pair, having one N×M block found in the forward reference block B1 and another N×M block found in the backward reference block B2, according to an embodiment of the present invention. FIG. 10 is a diagram illustrating a portion of different integer positions within one reference block B1/B2 according to an embodiment of the present invention. The forward reference block B1 generated from the bilateral filter circuit 216 has an initial block 902 pointed to by a first initial motion vector MV_{INI}1. The backward reference block B2 generated from the bilateral filter circuit 216 has an initial block 912 pointed to by a second initial motion vector MV_{INI}2. The first initial motion vector MV_{INI}1 and the second initial motion vector MV_{INI}2 depend on the specified motion vectors MV1 and MV2 of the current block 114 in the current picture 104, respectively. More specifically, the initial N×M block 902 of the forward reference block B1 may be obtained by passing the N×M center block 302 of the forward reference block K1 through the bilateral filter circuit 216, and the initial N×M block 912 of the backward reference block B2 may be obtained by passing the N×M center block 302 of the backward reference block K2 through the bilateral filter circuit 216. In this example, N is equal to M. However, this is for illustrative purposes only, and is not meant to be a limitation of the present invention.

The block position of the initial block 902/912 is determined by a pixel position of a top-left pixel (which may be an integer pixel or a fractional pixel) of the initial block 902/912, and is denoted by an integer position (0, 0). The APD processing circuit 802 first calculates an APD value of an initial block pair consisting of initial blocks 902 and 912. It is possible that the APD processing circuit 802 may need to calculate additional APD values for block pairs surrounding the initial block pair. As shown in FIG. 9, a block pair consisting of blocks 904 and 914 is selected by the APD processing circuit 802 for calculating an APD value. There are a non-zero motion vector offset ΔMV between a first motion vector MV_1 pointing to the block 904 and the first initial motion vector MV_{INI}1 (i.e. MV_1=MV_{INI}1+ΔMV), and a non-zero motion vector offset −ΔMV between a second motion vector MV_2 pointing to the block 914 and the second initial motion vector MV_{INI}2 (i.e. MV_2=MV_{INI}1−ΔMV). It should be noted that the non-zero motion vector offsets ΔMV and −ΔMV have the same magnitude but opposite directions. It should be noted that, except for the initial block pair, all candidate block pairs selected by the APD processing circuit 802 should have the above motion vector offset relationship (i.e., ΔMV and −ΔMV).

For example, when a forward block at an integer position (−1, −1) shown in FIG. 10 is selected from the forward reference block B1, a backward block at an integer position (1, 1) shown in FIG. 10 should be selected from the backward reference block B2 to paired with the forward block; when a forward block at an integer position (0, −1) shown in FIG. 10 is selected from the forward reference block B1, a backward block at an integer position (0, 1) shown in FIG. 10 should be selected from the backward reference block B2 to paired with the forward block; when a forward block at an integer position (1, −1) shown in FIG. 10 is selected from the forward reference block B1, a backward block at an integer position (−1, 1) shown in FIG. 10 should be selected from the backward reference block B2 to paired with the forward block; when a forward block at an integer position (−1, 0) shown in FIG. 10 is selected from the forward reference block B1, a backward block at an integer position (1, 0) shown in FIG. 10 should be selected from the backward reference block B2 to paired with the forward block; when a forward block at an integer position (1, 0) shown in FIG. 10 is selected from the forward reference block B1, a backward block at an integer position (−1, 0) shown in FIG. 10 should be selected from the backward reference block B2 to paired with the forward block; when a forward block at an integer position (−1, 1) shown in FIG. 10 is selected from the forward reference block B1, a backward block at an integer position (1, −1) shown in FIG. 10 should be selected from the backward reference block B2 to paired with the forward block; when a forward block at an integer position (0, 1) shown in FIG. 10 is selected from the forward reference block B1, a backward block at an integer position (0, −1) shown in FIG. 10 should be selected from the backward reference block B2 to paired with the forward block; when a forward block at an integer position (1, 1) shown in FIG. 10 is selected from the forward reference block B1, a backward block at an integer position (−1, −1) shown in FIG. 10 should be selected from the backward reference block B2 to paired with the forward block.

To get an APD value of one block pair, the APD processing circuit 802 accumulates the difference between one block found in the forward reference block B1 and another block found in the backward reference block B2. In one exemplary implementation, the APD processing circuit 802 may start to calculate one APD value once required pixels for APD calculation are available in the register array device 808. In another exemplary implementation, the APD processing circuit 802 may start to calculate any APD value after the whole forward reference block B1 and the whole backward reference block B2 are both stored in the register array device 808.

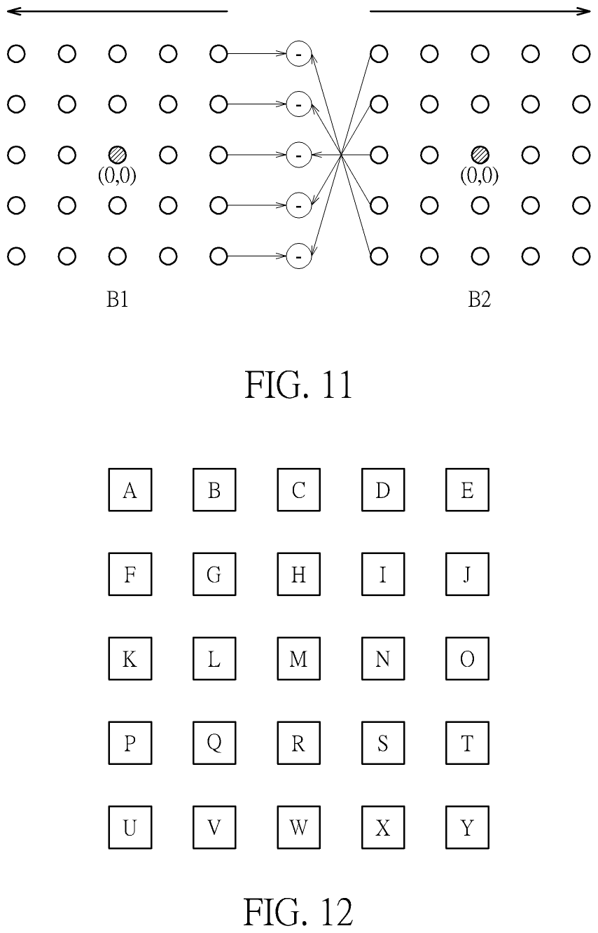

The APD processing circuit 802 may get APD values of Q×Q block pairs for a following processing stage. For example, Q may be equal to 5. Please refer to FIG. 11 in conjunction with FIG. 12. FIG. 11 is a diagram illustrating APD computation performed at the APD processing circuit 802 for obtaining 5×5 APDs values according to an embodiment of the present invention. FIG. 12 is a diagram illustrating a spatial distribution of 5×5 APD values according to an embodiment of the present invention. Regarding each of the 5×5 block pairs, a first block is selected from one of the 5×5 block positions in the forward reference block B1, and a second block at a paired block position selected from the 5×5 block positions in the backward reference block B2, where the first block and the second block selected by the APD processing circuit 802 have the above-mentioned motion vector offset relationship (i.e., ΔMV and −ΔMV). In this way, one APD value APD_i is calculated when one block pair has one block located at a block position i in the forward reference block B1, where i={A, B, C, D, E, F, G, H, I, J, K, L, M, N, O, P, Q, R, S, T, U, V, X, W, Y}. It should be noted that the block position M at the center of the 5×5 block positions shown in FIG. 12 represents the initial block position (0, 0).

The APD decision circuit 804 is arranged to refer to the APD calculation result for finding a block pair with the best APD, where the offset setting deltaOffset (deltaOffset=(deltaOffsetX, deltaOffsetY)) is determined according to a block position of the block pair with the best APD. In a case where the block position of the block pair with the best APD requires further fractional pixel refinement, the fractional pixel refinement circuit 806 is arranged to calculate a fractional offset setting deltaOffset_frac. The offset setting deltaOffset is set by an integer offset setting deltaOffset_int and the fractional offset setting deltaOffset_frac (i.e. deltaOffset=deltaOffset_int+deltaOffset_frac), where the integer offset setting deltaOffset_int is determined based on the block position of the block pair with the best APD found by the APD decision circuit 804. In another case where the block position of the block pair with the best APD does not require further fractional pixel refinement, the offset setting deltaOffset is directly determined based on the block position of the block pair with the best APD. That is, the offset setting deltaOffset only consists of the integer offset setting deltaOffset_int determined based on the block position of the block pair with the best APD found by the APD decision circuit 804.

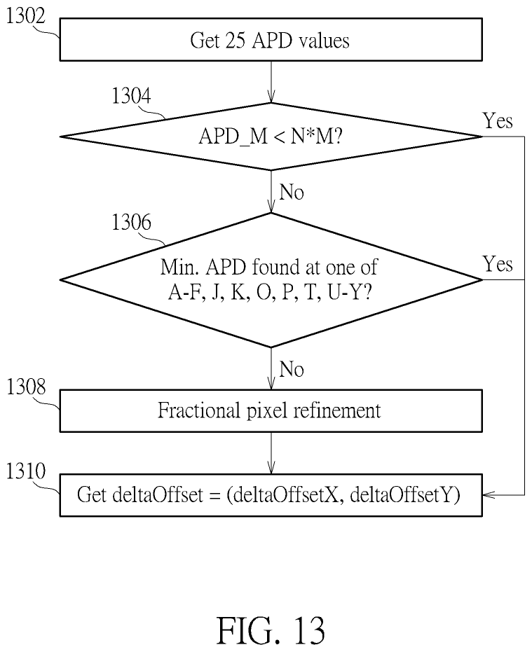

FIG. 13 is a flowchart illustrating a method for determining the offset setting deltaOffset according to an embodiment of the present invention. At step 1302, the APD decision circuit 804 gets 25 APD values APD_A-APD_Y from the APD processing circuit 802. At step 1304, the APD decision circuit 804 checks if an early termination condition is met by comparing the APD value APD_M of the initial block pair (which consists of initial blocks located at (0, 0) in forward reference block B1 and backward reference block B2) with a threshold value set by N×M (which is the size of the current block 114 in the current picture 104). When the early termination condition checked at step 1304 is met, the flow proceeds with step 1310. Hence, the offset setting (deltaOffsetX, deltaOffsetY) is set by the block position (0, 0) of the initial block pair with the APD value APD_M. When the early termination condition checked at step 1304 is not met, the flow proceeds with step 1306.

At step 1306, the APD decision circuit 804 checks if another early termination condition is met by finding a minimum APD value APD_j among the 25 APD values APD_A-APD_Y and checking a block position j of a specific block pair that possesses the minimum APD value APD_j. The early termination condition checked at step 1306 is met if the block position j of the specific block pair is one of {A, B, C, D, E, F, J, K, O, P, T, U, V, X, W, Y}. When the early termination condition checked at step 1306 is met, the flow proceeds with step 1310. Hence, the offset setting (deltaOffsetX, deltaOffsetY) is set by the block position j of the specific block pair with the minimum APD value APD_j. For example, when the minimum APD value APD_j is APD_A, the offset setting (deltaOffsetX, deltaOffsetY) is set by the block position (−2, −2) of the block pair with the APD value APD_A. For another example, when the minimum APD value APD_j is APD_W, the offset setting (deltaOffsetX, deltaOffsetY) is set by the block position (1, 2) of the block pair with the APD value APD_M.

When the early termination condition checked at step 1306 is not met, the flow proceeds with step 1308. The fractional pixel refinement circuit 806 calculates the fractional offset setting. At step 1310, the fractional pixel refinement circuit 806 may output the offset setting deltaOffset that is obtained by adding the fractional offset setting to the integer offset setting that is set based on the block position j of the specific block pair with the minimum APD value APD_j.

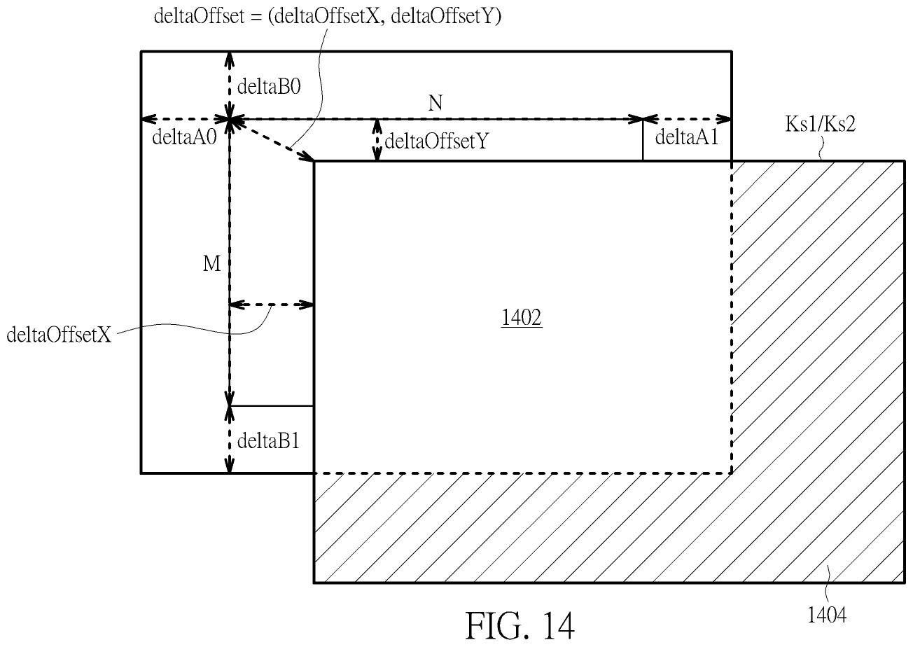

The block fetch circuit 208 is arranged to fetch the forward reference block K1 and the backward reference block K2 from the reference block buffer 212 allocated in the storage device 204, generate an output forward reference block Ks1 by selectively applying shifting and padding to the forward reference block K1 according to the offset setting deltaOffset, and generate an output backward reference block Ks2 by selectively applying shifting and padding to the backward reference block K2 according to the offset setting deltaOffset. FIG. 14 is a diagram illustrating an output reference block Ks1/Ks2 derived from applying shifting and padding to a reference block K1/K2 according to an embodiment of the present invention. As shown in FIG. 14, the output reference block Ks1/Ks2 includes a non-padding area 1402 and a padding area 1404, where the non-padding area 1402 overlaps the reference block K1/K2, and the padding area 1404 is outside of the reference block K1/K2. Pixels included in the non-padding area 1402 are set by pixels include in an overlapped area of the reference block K1/K2. Pixels included in the padding area 1404 are created by pixel padding. In addition, the block fetch circuit 208 is further arranged to provide the motion compensation circuit 10 with the offset setting deltaOffset, the output forward reference block Ks1, and the output backward reference block Ks2.

In one exemplary implementation, the reference block fetch circuit 202, the processing circuit 206 (which includes bilateral filter circuit 216 and offset calculation circuit 218) and the block fetch circuit 208 may operate in a sequential processing fashion. In another exemplary implementation, the reference block fetch circuit 202, the processing circuit 206 (which includes bilateral filter circuit 216 and offset calculation circuit 218) and the block fetch circuit 208 may operate in a parallel processing fashion. For example, during a process of searching for an offset setting used by motion vector refinement of specified motion vectors of a current block, at least two of the main function blocks, including reference block fetch circuit 202, bilateral filter circuit 216, offset calculation circuit 218 and the block fetch circuit 208, may operate at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion vector refinement apparatus comprising:
a storage device;
a reference block fetch circuit, arranged to fetch a forward reference block in a forward reference picture and a backward reference block in a backward reference picture according to at least specified motion vectors (MVs) of a current block in a current picture, and store the forward reference block and the backward reference block into the storage device; and
a processing circuit, arranged to derive a first reference block from the forward reference block and a second reference block from the backward reference block, calculate at least one accumulated pixel difference (APD) value for at least one block pair each having a first block found in the first reference block and a second block found in the second reference block, and determine an offset setting for motion vector refinement of the specified MVs according to said at least one APD value.

2. The motion vector refinement apparatus of claim 1, wherein the first reference block comprises a first initial block pointed to by a first initial MV, the second reference block comprises a second initial block pointed to by a second initial MV, the first initial MV and the second initial MV depend on the specified MVs of the current block, a non-zero MV offset between a first MV pointing to the first block and the first initial MV and a non-zero MV offset between a second MV pointing to the second block and the second initial MV have a same magnitude but opposite directions.

3. The motion vector refinement apparatus of claim 1, wherein the reference block fetch circuit is arranged to start fetching one of the forward reference block and the backward reference block after completing fetching of another of the forward reference block and the backward reference block.

4. The motion vector refinement apparatus of claim 1, wherein the reference block fetch circuit is arranged to start fetching one of the forward reference block and the backward reference block before completing fetching of another of the forward reference block and the backward reference block.

5. The motion vector refinement apparatus of claim 1, further comprising:
a block fetch circuit, arranged to fetch the forward reference block and the backward reference block from the storage device, generate an output forward reference block by selectively applying shifting and padding to the forward reference block according to the offset setting, generate an output backward reference block by selectively applying shifting and padding to the backward reference block according to the offset setting, and provide a motion compensation circuit with the offset setting, the output forward reference block, and the output backward reference block.

6. The motion vector refinement apparatus of claim 5, wherein at least two of the reference block fetch circuit, the processing circuit, and the block fetch circuit operate in a parallel processing fashion.

7. The motion vector refinement apparatus of claim 1, wherein a size of the current block is N×M, N represents a block width, M represents a block height; the reference block fetch circuit is arranged to obtain the specified MVs and a plurality of parameters including deltaA0, deltaA1, deltaB0, deltaB1, fetch the forward reference block in the forward reference picture according to the plurality of parameters and one of the specified MVs, and fetch the backward reference block in the backward reference picture according to the plurality of parameters and another of the specified MVs; regarding a reference block being any of the forward reference block and the backward reference block, the reference block comprises an N×M center block found via a corresponding specified MV, and has a size of (N+deltaA0+deltaA1)×(M+deltaB0+deltaB1), where deltaA0 specifies an offset between a left boundary of the reference block and a left boundary of the N×M center block, deltaA1 specifies an offset between a right boundary of the reference block and a right boundary of the N×M center block, deltaB0 specifies an offset between a top boundary of the reference block and a top boundary of the N×M center block, and deltaB1 specifies an offset between a bottom boundary of the reference block and a bottom boundary of the N×M center block.

8. The motion vector refinement apparatus of claim 1, wherein the processing circuit comprises:
a bilateral filter circuit, arranged to derive the first reference block by applying bilateral filtering to the forward reference block, derive the second reference block by applying bilateral filtering to the backward reference block, and store the first reference block and the second reference block into the storage device.

9. The motion vector refinement apparatus of claim 8, wherein the bilateral filter circuit reads the storage device to obtain the forward reference block and the backward reference block from the storage device.

10. The motion vector refinement apparatus of claim 8, wherein the reference block fetch circuit is further arranged to transmit the forward reference block and the backward reference block to the bilateral filter circuit.

11. The motion vector refinement apparatus of claim 8, wherein the bilateral filter circuit is arranged to start applying bilateral filtering to one of the forward reference block and the backward reference block after completing bilateral filtering of another of the forward reference block and the backward reference block.

12. The motion vector refinement apparatus of claim 8, wherein the bilateral filter circuit is arranged to start applying bilateral filtering to one of the forward reference block and the backward reference block before completing bilateral filtering of another of the forward reference block and the backward reference block.

13. The motion vector refinement apparatus of claim 1, wherein said at least one APD value comprises an APD value of an initial block pair pointed to by initial MVs that depend on the specified MVs of the current block, and the processing circuit comprises:
an offset calculation circuit, comprising:
an APD processing circuit, arranged to calculate the APD value of the initial block pair; and
an APD decision circuit, arranged to determine if the APD value for the initial block pair meets an early termination condition, wherein in response to determining that the APD value for the initial block pair meets the early termination condition, the APD decision circuit determines the offset setting according to block positions of the initial block pair.

14. The motion vector refinement apparatus of claim 1, wherein said at least one APD value comprises a plurality of APD values of a plurality of block pairs surrounding an initial block pair pointed to by initial MVs that depend on the specified MVs, and the processing circuit comprises:
an offset calculation circuit, comprising:
an APD processing circuit, arranged to calculate the plurality of APD values of the plurality of block pairs, respectively;
an APD decision circuit, arranged to find a minimum APD value from the plurality of APD values, and determine if the minimum APD value possessed by a specific block pair meets an early termination condition, wherein in response to determining that the minimum APD value of the specific block pair meets the early termination condition, the APD decision circuit determines the offset setting according to block positions of the specific block pair.

15. The motion vector refinement apparatus of claim 1, wherein the offset setting comprises an integer offset setting and a fractional offset setting, said at least one APD value comprises an APD value of an initial block pair pointed to by initial MVs that depend on the specified MVs and a plurality of APD values of a plurality of block pairs surrounding the initial block pair, and the processing circuit comprises:
an offset calculation circuit, comprising:
an APD processing circuit, arranged to calculate the APD value of the initial block pair, and calculate the plurality of APD values of the plurality of block pairs, respectively;
an APD decision circuit, arranged to find a minimum APD value from the APD value and the plurality of APD values, and determine the integer offset setting according to block positions of a specific block pair with the minimum APD value; and
a fractional pixel refinement circuit, arranged to calculate the fractional offset setting.

16. The motion vector refinement apparatus of claim 1, wherein the processing circuit comprises:
an offset calculation circuit, comprising:
a register array device, arranged to receive the first reference block and the second reference block; and
an APD processing circuit, arranged to calculate said at least one APD value according to pixels stored in the register array device.

17. The motion vector refinement apparatus of claim 1, wherein the APD processing circuit starts to calculate said at least one APD value once required pixels are available in the register array device.

18. The motion vector refinement apparatus of claim 1, wherein the APD processing circuit starts to calculate said at least one APD value after the first reference block and the second reference block are both stored in the register array device.

19. The motion vector refinement apparatus of claim 1, wherein the motion vector refinement apparatus is a part of a Versatile Video Coding (VVC) decoder.

20. A motion vector refinement method comprising:
fetching a forward reference block in a forward reference picture and a backward reference block in a backward reference picture according to at least specified motion vectors (MVs) of a current block in a current picture;
deriving a first reference block from the forward reference block and a second reference block from the backward reference block;
calculating, by an offset calculation circuit, at least one accumulated pixel difference (APD) value for at least one block pair, each having a first candidate block found in the first reference block and a second candidate block found in the second reference block; and
according to said at least one APD value, determining an offset setting for motion vector refinement of the specified MVs.
